(19) United States
(12) Patent Application Publication
(10) Pub. No.: US 2018/0214337 A1
(43) Pub. Date: Aug. 2, 2018

(54) APPARATUS FOR ASSISTING A USER IN RISING FROM A SEATED POSITION ONTO A WALKER

(71) Applicant: Gustav Hubert, Pasadena, CA (US)

(72) Inventor: Gustav Hubert, Pasadena, CA (US)

(21) Appl. No.: 15/422,889

(22) Filed: Feb. 2, 2017

(51) Int. Cl. A61H 3/04

(52) U.S. Cl. CPC A61H 3/04; A61H 2003/046

(57) ABSTRACT

An apparatus for assisting a user in rising from a seated position onto a walker is presented. The invention is a stabilizer assembly with a hinge coupled to the wheelbase of each front leg of a walker. A stabilizer bar configured to be in a stowed or deployed position is coupled to the hinge. The stabilizer bar is configured to lay substantially flat on the ground and angled away from front wheel centerline when in the deployed position such that the walker is restrained from movement when a caregiver steps on the stabilizer bar.

### BACKGROUND OF THE INVENTION

### Field of the Invention

Embodiments of the invention relates to the field of medical devices. More specifically, the invention relates to an apparatus for assisting a user in rising from a seated position onto a walker.

### Description of the Related Art

People that use walkers generally require assistance to stand from a seated position because the walkers have a tendency to roll, when not restrained. In most cases, these people have a disability, are infirm because of age, are recovering from illness or surgical procedure, or have some other type of condition that limits their ambulatory capabilities. Because the walker is not restrained, most caregivers have certain methods for assisting these persons to stand from a seated position.

The simplest method is to physically lift the person without the aid of any devices. This method, though, has many shortcomings. For instance, many persons who require standing assistance may not have a caregiver that is physically capable of lifting them from a seated position. Even where such a physically capable caregiver is available, physically lifting an infirm person, e.g. an adult, may cause injury to the lifter because the lifter is required to lift a large weight or lift from an awkward position. Further, the infirm person being lifted is also at risk because of potentially unstable situation of the awkward lift, which may result in falls.

More complicated systems are available in the prior art for assisting an infirm person from a seated position to a standing position with a walker. For example, a full body sling lift may be used for persons who have no weight bearing ability in their legs. While such devices may be useful in certain applications, they are difficult and time consuming to use. Further, these devices generally are not appropriate for persons who have some ambulatory capabilities and only require assistance to stand.

Also available in the prior art for assisting an infirm person from a seated position to a standing position with a walker is a gate belt. A gate belt may be used to help a person attain a standing position so that they may use a walker or pivot to another sitting position. Although gate belts may be effective for certain applications, they still tend to create an unstable situation during the lifting which leads to frequent falls and injuries. The risk of injury is further heightened due to the twisting and ergonomically unsafe positioning that occurs during a gate belt lift.

To overcome the problems and limitations described above, there is a need for a simple and effective apparatus for assisting a user in rising from a seated position onto a walker.

### BRIEF SUMMARY OF THE INVENTION

One or more embodiments of the invention are directed an apparatus for assisting a user in rising from a seated position onto a walker. The apparatus is a stabilizer assembly comprising a hinge coupled to a wheelbase of a front leg of a walker. The hinge may be coupled to a base (or leg) plate, and the leg plate is coupled to the front leg, or the hinge may be coupled directly to the leg of the walker.

The invention comprises a stabilizer bar coupled to the other end of the hinge. The stabilizer bar is configured to be stowable when not in use. When in use, the stabilizer bar is configured to lay substantially flat on a floor (or ground) in its deployed position. In this deployed position, the stabilizer bar is configured such that a caregiver can step on it to restrain the walker from movement thereby providing support for a user rising from a seated position to a standing position.

In one or more embodiments, the stabilizer bar is configured as an L-shaped member coupled to each front leg wheelbase of the walker via the hinge.

In one or more embodiments, the stabilizer assembly further comprises a latch coupled to the leg of the walker to secure the stabilizer bar in the stowed position. The latch could be magnetic, for example, if the stabilizer bar is metallic or contains metallic components. The latch could also be a hook or similar devices.

In one or more embodiments, the hinge may be configured with an interlocking mechanism with one or more discrete lock positions (e.g. sprockets) to hold the stabilizer bar away from the deployed position. For instance, the hinge could be keyed, configured like a sprocket type device, configured with friction type lock, etc. In such configurations, a separate latch device may not be necessary to hold the stabilizer bar away from the deployed position.

In one or more embodiments, the stabilizer bar is coupled at an angle of approximately −45 degrees from an inside face of the front wheelbase such that the stabilizer bar protrudes outwards away from a user of the walker.

### BRIEF DESCRIPTION OF THE DRAWINGS

The above and other aspects, features and advantages of the invention will be more apparent from the following more particular description thereof, presented in conjunction with the following drawings wherein:

FIG. 1 is an illustration of a walker with the stabilizer apparatus on both front wheels in a deployed position in accordance with one or more embodiments of the present invention.

FIG. 2 is an illustration of a walker with the stabilizer apparatus on one front wheel in a deployed position and the stabilizer apparatus on the other front wheel in a stowed position in accordance with one or more embodiments of the present invention.

FIG. 3 is close-up view of the stabilizer apparatus on one wheel in a deployed position in accordance with one or more embodiments of the present invention.

FIG. 4 is close-up view illustrating coupling of a deployed stabilizer apparatus with a front leg of the walker in accordance with one or more embodiments of the present invention.

FIG. 5 is close-up view illustrating coupling of a stowed stabilizer apparatus with a front leg of the walker in accordance with one or more embodiments of the present invention.

### DETAILED DESCRIPTION

The present invention comprising an apparatus for assisting a user in rising from a seated position onto a walker will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

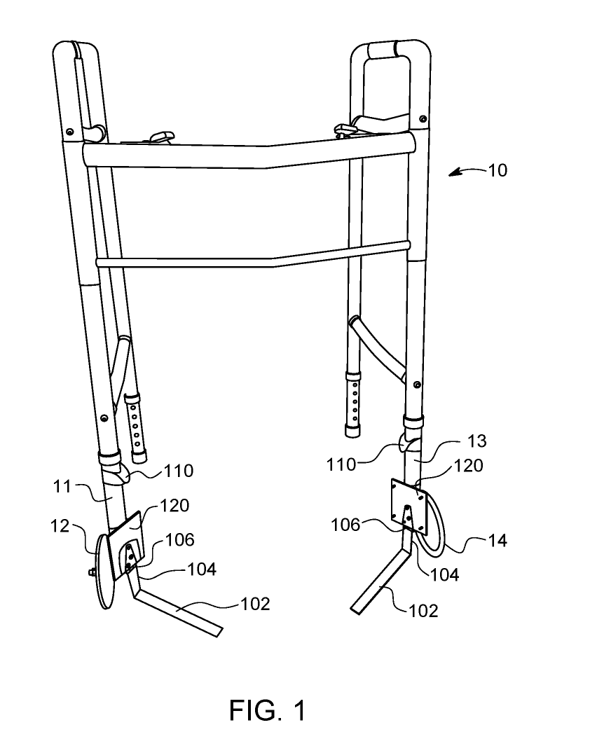

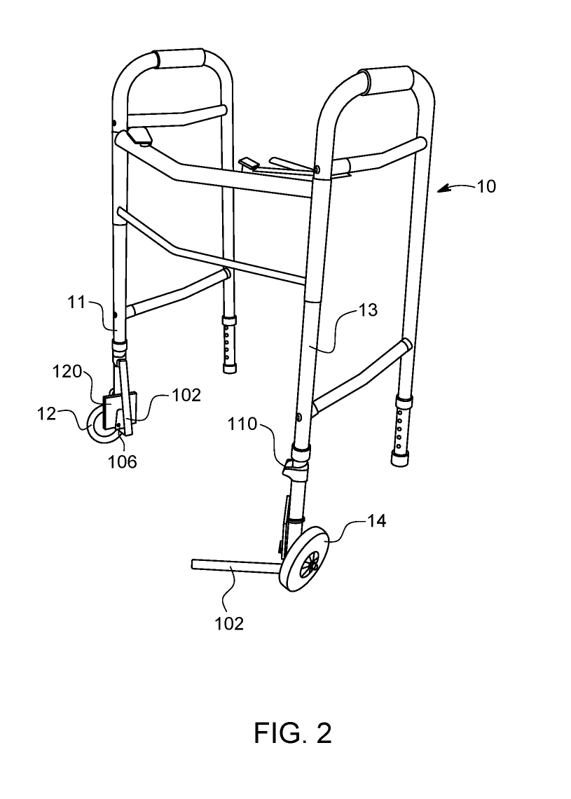

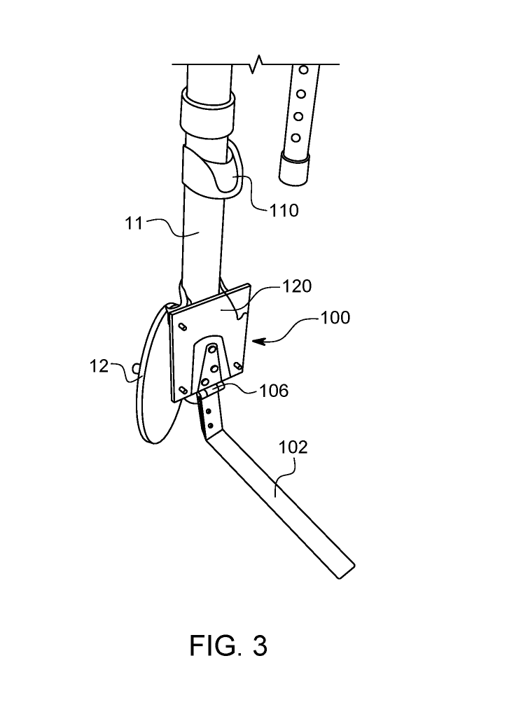

One or more embodiments of the present invention will now be described with references to FIGS. 1-5.

One or more embodiments the stabilizer assembly 100 for assisting a user in rising from a seated position onto a walker comprises a stabilizer bar 102 on each front wheel that lays flat on the ground when deployed. In the deployed state, a caregiver can step on one or both of the stabilizer bars thus immobilizing and stabilizing the walker such that an infirmed person can raise him/herself from a seated position to a standing position with support of the walker. The stabilizer assembly may be built into new walkers or coupled to existing walkers.

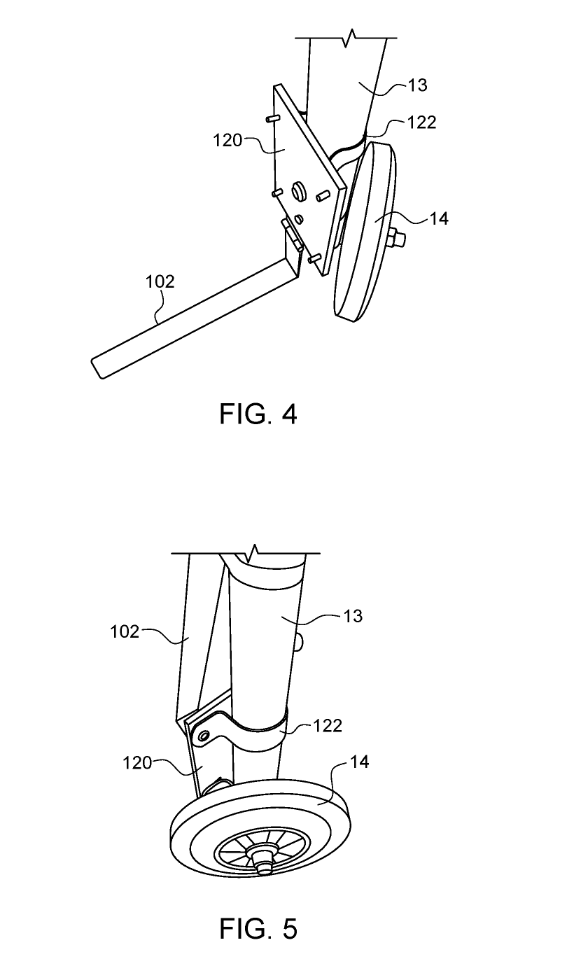

As illustrated, one or more embodiments of stabilizer apparatus 100 comprises a leg plate 120; a hinge 106; a stabilizer bar 102-104; and a latch 110. The leg plate 120 is configured to be coupleable to the bottom end of a front leg (i.e. base of the leg) of the walker, e.g. 11 and 13, near the front wheel, e.g. 12 and 14. As illustrated in FIGS. 4 and 5, the leg plate may be coupled to the front leg with one or more braces 122. Other forms of coupling may also be used. For example, the leg plate may be molded directly into or made part of the front leg of the walker.

In one or more embodiments, a first end of a hinge 106 is coupled to the leg plate 120 at the front wheelbase of the leg of the walker. In other embodiments, the leg plate 120 may be eliminated and the hinge 106 coupled directly to the front leg of the walker.

The stabilizer bar comprises a base member 102 coupled to a bottom end of a substantially vertical member 104. The top end of the vertical member 104 is coupled to the second end of hinge 106. The stabilizer bar is configured to have a stowed position and a deployed position. In the deployed position, the base member 102 of the stabilizer bar is configured to substantially lay flat on the ground. The stabilizer bar is preferably metallic, but could be made of other type materials, e.g. composites, plastics, etc.

One or more embodiments of the present invention further comprises a latch 110 coupled to the leg of the walker, towards the midsection of the leg. The latch is configured to secure the stabilizer bar in the stowed position. The latch could be any structure that can secure the stabilizer bar in the secured position. For example, the latch 110 could be magnetic, if the stabilizer includes a metal component. The latch 110 could also be a hook or similar device that allows for ease of deployment of the stabilizer bar.

Those of skill in the art would appreciate that some embodiments are contemplated without the latch 110. For instance, hinge 106 may be configured to use an interlocking mechanism with one or more discrete lock positions (e.g. sprockets) or friction to hold the stabilizer bar away from the deployed position. Thus, the stabilizer bar 102 may be stowed in different ways without deviating from the invention.

In one or more embodiments, the stabilizer bar is coupled at an angle of approximately −45 degrees (i.e. clockwise rotation on left front wheel and counter-clockwise rotation on right front wheel) from an inside face (i.e. centerline) of the front wheelbase such that the base member 102 protrudes outwards and away from the user. The angular position of the base member could be between 0 and −180 degrees (i.e. from the centerline of the front wheels). Thus, the stabilizer bar could be on the side or front of the walker.

Those of skill in the art would appreciate that other embodiments are contemplated. For instance, an embodiment of the stabilizer assembly may comprises a left stabilizer bar conjoined with a right stabilizer bar, wherein the left stabilizer bar is coupled to the left front wheel and the right stabilizer bar is coupled to the right front wheel. In addition, the stabilizer assembly could be configured such that its deployment creates the needed resistance (or restraint) that prevents the leg of the walker from movement thereby providing support for a user rising from a seated position to a standing position. For instance, the bottom end of the stabilizer assembly could be equipped with rubber boots that create the needed resistance, e.g. kick-down door holders.

While the invention herein disclosed has been described by means of specific embodiments and applications thereof, numerous modifications and variations could be made thereto by those skilled in the art without departing from the scope of the invention set forth in the claims.

What is claimed is:

1. An apparatus for assisting a user in rising from a seated position onto a walker comprising:
a hinge with a first end coupled to a wheelbase of a front leg of a walker;
a stabilizer bar having a stowed position and a deployed position, wherein the stabilizer comprises a base member coupled to a bottom end of a substantially vertical member, wherein a top end of the vertical member is coupled to a second end of said hinge, wherein the base member is configured to lay flat on a floor when in the deployed position; and
a latch coupled to the leg of the walker to secure the stabilizer bar in the stowed position.

2. The apparatus of claim 1, wherein the base member is configured to be stepped on to restrain movement of the walker thereby providing support when a user is rising from a seated position.

3. The apparatus of claim 1, wherein the stabilizer bar is coupled at an angle of approximately −45 degrees from an inside face of said front wheelbase such that the base member protrudes outwards away from a user of the walker.

4. The apparatus of claim 1, wherein the latch is magnetic.

5. The apparatus of claim 1, wherein the latch is a hook.

6. An apparatus for assisting a user in rising from a seated position onto a walker comprising:
a stabilizer assembly, wherein the stabilizer assembly comprises:
a hinge with a first end coupled to a wheelbase of a front leg of a walker; and
a stabilizer bar having a stowed position and a deployed position, wherein a first end of the stabilizer bar is coupled to a second end of said hinge, wherein the stabilizer bar is configured to lay substantially flat on a floor when in the deployed position such that the walker is restrained from movement when a caregiver steps on the stabilizer bar.

7. The apparatus of claim 6, wherein the stabilizer bar is coupled at an angle of approximately −45 degrees from an inside face of said front wheelbase such that the stabilizer bar protrudes outwards away from a user of the walker.

8. The apparatus of claim 6, wherein the stabilizer assembly further comprises a latch for holding the stabilizer bar away from the deployed position when not in use.

9. The apparatus of claim 6, wherein one of said stabilizer assembly is coupled to each front wheel of the walker.

10. An apparatus for assisting a user in rising from a seated position onto a walker comprising:
a stabilizer assembly, wherein the stabilizer assembly comprises:
a hinge with a first end configured to be coupleable to a wheelbase of a front leg of a walker; and
a stabilizer bar having a stowed position and a deployed position, wherein a first end of the stabilizer bar is coupled to a second end of said hinge, wherein the stabilizer bar is configured to lay substantially flat on a floor when in the deployed position such that the walker is restrained from movement.

11. The apparatus of claim 10, wherein the stabilizer assembly further comprises a latch coupleable to said front leg for holding the stabilizer bar away from the deployed position when not in use.

12. The apparatus of claim 10, wherein the first end of the hinge is coupled to a leg plate and the leg plate is coupleable to the wheelbase of the front leg of the walker.

13. The apparatus of claim 10, wherein the hinge is coupleable to the wheelbase of the front leg of the walker with one or more braces.
